(19) United States
(12) Patent Application Publication
(10) Pub. No.: US 2008/0000764 A1
(43) Pub. Date: Jan. 3, 2008

(54) Control element for a motor vehicle

(76) Inventor: Anton Ruettiger, Wildflecken (DE)

Correspondence Address: MCGRATH, GEISSLER, OLDS & RICHARDSON, PLLC, P.O. BOX 1364, FAIRFAX, VA, 22038-1364, US

(21) Appl. No.: 11/802,933

(22) Filed: May 25, 2007

Related U.S. Application Data
(63) Continuation of application No. PCT/EP05/12629, filed on Nov. 25, 2005.

(30) Foreign Application Priority Data
Nov. 25, 2004 (DE) DE10 2004 056 834

(51) Int. Cl. H01H 9/00

(52) U.S. Cl. 200/314

(57) ABSTRACT

A control element is provided with fully integrated control elements with integrated illumination, switching element, and contact set. The functional assignment of the individual control elements in the control panel is accomplished by means of software through a bus system. A universal control panel with complete control elements is thus made available. Along with a drastic reduction in the number of variations, and thus the logistical expenses, later functional expansion of the relevant control panel is possible.

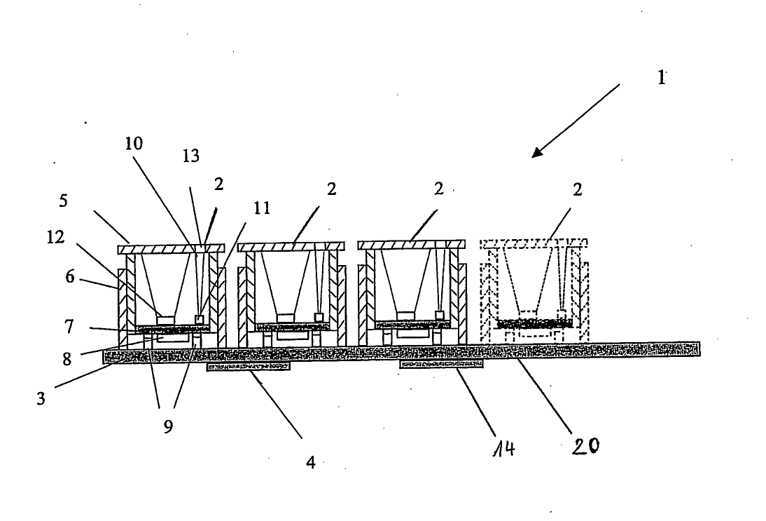

This nonprovisional application is a continuation of International Application No. PCT/EP2005/012629, which was filed on Nov. 25, 2005, and which claims priority to German Patent Application No. DE 102004056834, which was filed in Germany on Nov. 25, 2004, and which are both herein incorporated by reference.

### BACKGROUND OF THE INVENTION

1. Field of the Invention

The present invention relates to a control panel for a data input and/or output device that is connected through at least one interface to a bus system to which are also connected functional modules to be controlled, in particular in the field of motor vehicle electronics.

2. Description of the Background Art

Wide use is made of control elements such as switches, or entire control panels or keyboards in the case of large numbers of different functions, in order to activate an extremely wide variety of functions. This has the result that the keyboard becomes increasingly cumbersome and expensive with a large number of functions to be controlled. The keycaps of the switching elements are labeled by a symbol or legend corresponding to the underlying function. DE 40 18 411 A1 shows a current method for labeling keycaps.

There are a variety of approaches for permitting multiple assignment of buttons in order to minimize the number of buttons as the number of functions to be actuated increases. Thus, systems with a reduced number of buttons and menu control have been developed, for example using a video screen.

DE 103 42 142 A1, which corresponds to U.S. Publication No. 2006209029, is based on the idea of generating the image of the symbols to be represented by means of a display, for example an LCD, and directly projecting it in the interior of a control element, for example in the upper part of a knob or in a keycap. The projection layer is, for example, a diffusion layer in the keycap, which can be applied either to the inside or the outside of the keycap, the material of the keycap itself, or any other desired method that permits the generation of an intermediate image in the keycap. This permits freely programmable symbols for a control element.

DE 197 39 357 A1, among others, provides for the use of a bus system to improve the control and regulation of the individual electronic components, as for example control elements, momentary switches, switches, etc. in the motor vehicle.

One task in individual mass production of motor vehicles is that the control panels must be provided in all desired variations as complete switch arrays, light switches, control knobs, selection switches, etc. Frequently, the selective installation of the necessary control elements or the attachment of the keycaps with function indicators or the insertion of blank plugs in the control elements takes place only on site.

### SUMMARY OF THE INVENTION

It is therefore an object of the present invention to provide a control panel with which the expense of fabrication and assembly of different control panels can be reduced, and thus a very simple reduction in the number of variations of the control panels can be achieved.

The invention is based on the idea of equipping the control element as a base unit in such a manner that, for each control element installed in the base unit, all required electronics and connections necessary for the function of the control element, as for example integrated illumination, switch element, contact set, etc., are present. The assignment of the functions of the individual control elements in the base unit and thus in the control panel is performed by means of software. In this way, a universally applicable control panel with control elements that can be freely assigned is provided. It is advantageous in this regard that the number of variants is essentially unrestricted, and that the logistical expenditure in the installation of the control panel is thus reduced, while allowing a later functional expansion of the relevant control panel.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, are not limitive of the present invention, and wherein the FIGURES shows a cross-sectional view of a control panel.

### DETAILED DESCRIPTION

The sole FIGURE shows a cross-sectional sketch of the design of a control panel 1, in its assembled state, having control elements 2 that are standardized with regard to contacting in a base unit 20 and that are attached in common to a circuit board 3. The circuit board 3 is connected to a bus system, not shown in detail, by at least one plug connection 4.

The functional modules, also not shown, by means of which the assignment of functions of the individual control elements takes place, are connected to the bus system.

The design of a control element 2, which is a pushbutton 5 in this example embodiment, can be described as follows.

The pushbutton 5 is held and guided in a pushbutton guide 6 that makes up the base unit 20 at least together with the circuit board 3 and the electrical components. Integrated into the pushbutton 5 is a pushbutton circuit board 7 with electronics associated with the pushbutton 5, a momentary switch 8, as well as contacts 9, wherein the contacts 9 of the pushbutton 5 establish the electrical connection of the pushbutton 5 with the circuit board 3. In addition, the pushbutton 5 has a first LED 12 for a night design and an additional LED 11 for a function illumination, wherein the light from the LED 11 can be guided through a light guide 10, for example a 2-component light guide, to a predefinable area of a function symbol of the pushbutton 5. The functional symbol is reproduced by a front-side glass bead filling 13 and can have a varied design in this regard.

The electronics integrated into the pushbutton 5 achieve the result that the pushbutton 5 now only needs to be electrically incorporated into the base unit 20. The recognition and the assignment of the pushbutton 5 to the control element 1 takes place by means of software. A function is assigned to the individual control element 2 by means of the plug connection 4. Control elements 2 that are not to be assigned are not connected, which is to say that their in-house circuit boards 7 or their electronics are not supplied with current/voltage.

The essential components for this compact design are an integrated illumination 11, 12 in the form of an LED or adequate luminous means, a switch element 8 and a contact set 9. The control element 1 can be driven by means of the plug connector 4; however, it is also possible according to the invention to integrate a microcontroller here including a CAN or LIN bus interface building block.

However, the control panel 1 can also be designed as a basic module with, for example, 3 pushbutton versions, with various pushbuttons in the basic design, and multiple blank pushbuttons 2 (blank control elements) which may possibly also have varying basic designs, wherein the functions of these pushbuttons are displayed by means of the glass bead filling 13 when functions are assigned to these blank pushbuttons 2.

One possible alternative embodiment is a basic module that has control elements 2 with a function indicator for the basic functions and is populated with blank control elements 2 for additional functions.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control panel for a motor vehicle with a connection to a bus system, the control panel comprising:
a circuit board; and
control elements that are attached to the circuit board, the control elements being implemented in a compact design with integrated illumination, a switching element, a contact set, and a separate circuit board with base electronics,
wherein the control elements are selectively connected, via software, to the bus system through plug connections on the circuit board.

2. The control panel according to claim 1, wherein the integrated illumination is accomplished with luminous means, in particular light emitting diodes.

3. The control panel according to claim 2, wherein the light from the light emitting diodes is guided through a light guide to a predefinable area of the function symbol of the pushbutton, where a front-side glass bead filling is located.

4. The control panel according to claim 1, wherein the control element is a pushbutton with a pushbutton guide.

5. The control panel according to claim 1, wherein multiple control elements with identical and/or different basic structures and/or multiple blank control elements with identically and/or differently designed basic structures are attached to the circuit board.

6. The control panel according to claim 3, wherein, when functions are assigned to the pushbuttons, the functions of these pushbuttons are displayed via the glass bead filling.

7. The control panel according to claim 1, wherein control elements with a function indicator for the basic functions, and blank control elements for the additional functions, are present.

8. The control panel according to claim 1, wherein the control element is contacted and controlled by an interface building block.

9. A control panel for a motor vehicle comprising:
a circuit board with at least one interface building block and at least one pushbutton guide affixed to the circuit board;
contacts arranged within the pushbutton guide, wherein a pushbutton is introduced into the pushbutton guide and the pushbutton has at least one electrical connection corresponding to the contacts of the circuit board;
a circuit board that is integrated in the pushbutton and upon which is arranged at least one luminous component that emits light in a direction of a keycap equipped with at least one translucent region; and
a switching element that is located on the circuit board and is provided with electrical components.
